(19) United States
(12) Patent Application Publication
(10) Pub. No.: US 2011/0024614 A1
(43) Pub. Date: Feb. 3, 2011

(54) SIFT-MS INSTRUMENT

(75) Inventors: Paul Francis Wilson, Christchurch (NZ); Geoffrey Charles Peck, North Canterbury (NZ)

Correspondence Address: OBLON, SPIVAK, MCCLELLAND MAIER & NEUSTADT, L.L.P., 1940 DUKE STREET, ALEXANDRIA, VA, 22314, US

(73) Assignee: SYFT Technologies Limited, Christchurch (NZ)

(21) Appl. No.: 12/445,817

(22) PCT Filed: Oct. 19, 2007
(86) PCT No.: PCT/NZ2007/000313

§ 371 Date: Oct. 15, 2010

(30) Foreign Application Priority Data
Oct. 19, 2006 (NZ) 549911

(51) Int. Cl. H01J 49/40; H01J 49/28

(52) U.S. Cl. 250/282; 250/294

(57) ABSTRACT

A method of improving signal intensity of precursor ions constrained in a carrier gas in the flow tube of a SIFT-MS instrument, and an apparatus to carry out the method. The method applies an electrical potential to the flow tube to lower the diffusive loss of ions within the flow tube. The lowered diffusive loss of ions increases the sensitivity of the technique.

### TECHNICAL FIELD

This invention relates to selected ion flow mass spectrometry (SIFT-MS). More particularly it relates to an improvement in a SIFT-MS instrument that is intended to improve the sensitivity of the technique by increasing the intensity of the precursor ion signal.

### BACKGROUND TO THE INVENTION

SIFT-MS is a technique that is used to monitor volatile components in air in real time. The basis of the technique is that precursor ions (commonly H₃O⁺, O₂⁺ and NO⁺) are generated in a vacuum chamber at the upstream end of a flow tube. The ions are then mass selected using a mass filter and injected into the flow tube against a pressure gradient by use of a Venturi nozzle.

The mass selected precursor ions are then entrained in a carrier gas and flow down the flow tube. Helium is usually chosen as the carrier gas because it has a low molecular weight and thus the energy transfer in collisions between ions and the carrier gas in the injection process is minimised. In some cases, helium is mixed with other higher molecular mass inert gases to reduce diffusive losses of the ions. Reducing the energy of the collisions reduces the extent of fragmentation of the precursor ions during injection.

A known flow of sample may be introduced to the flow tube by means of a heated capillary tube and chemical reactions will take place between the analyte species and the precursor ions. The extent of the reaction is monitored by measuring the reduction of intensity of the precursor ion signal, and the magnitude of product ion signals at the end of the flow tube. From the comparison of primary (precursor) and product ion signals, the identity and concentration of volatile species in the sample may be calculated if the reaction rate and flow dynamics of the system are known.

A SIFT-MS apparatus is decribed in WO 2005/052984. In that apparatus an upstream quadrupole and a downstream quadrupoe are housed in a single evacuated chamber. The chamber is divided into sections by an electrostatic shield. The quadrupoles are connected through a curved flow tube. The contents of WO 2005/052984 are hereby incorporated by reference.

The sensitivity of the technique depends on the number of precursor ions that reach the downstream end of the flow tube. The greater the intensity of the precursor ion signal, measured in counts per second (cps), the greater the sensitivity of the technique. Most of the ion loss within the flow tube at low concentrations of analyte occurs as a result of diffusive loss to the flow tube walls of the ions in the carrier gas.

### OBJECT OF THE INVENTION

The object of at least one aspect of the invention is to improve the signal intensity of the precursor ions at the downstream end of the flow tube of a SIFT-MS instrument.

### DISCLOSURE OF THE INVENTION

In one form the invention is a method of improving the signal intensity of the precursor ions constrained in a carrier gas in the flow tube of a SIFT-MS instrument comprising the application of an electrical potential to the flow tube to lower the diffusive loss of ions within the flow tube.

In one embodiment the electrical potential is direct current.

In another embodiment the electrical potential is alternating current.

In another embodiment the electrical potential is a radio frequency field.

In one embodiment the flow tube is electrically insulated from the rest of the SIFT-MS equipment to allow the electrical potential to be applied to the flow tube.

In one embodiment the electrical potential is applied to the wall of the flow tube.

In one embodiment the electrical potential is applied to the flow tube by means of an electrode located within the flow tube.

In one embodiment the electrical potential is a negative voltage.

In another embodiment the electrical potential is a positive voltage.

In one embodiment the electrical potential is in the range of −100 VDC to +100 VDC.

In another embodiment the electrical potential is in the range of between +1 VDC to +50 VDC

In another embodiment the electrical potential is in the range of between +5 VDC to +50 VDC,

In one embodiment the applied electrical potential is a positive polarity when positive precursor ions are being sampled.

In another embodiment the applied electrical potential is a negative polarity when negative precursor ions are being sampled.

In another form the invention is a SIFT-MS instrument having a flow tube and including means to provide an electrical potential to the flow tube to lower the diffusive loss of ions within the flow tube.

In one embodiment the means to provide an electrical potential is a source of direct current.

In another embodiment the means to provide an electrical potential is a source of alternating current.

In one embodiment the means to provide an electrical potential is an electrode located within the flow tube.

In another embodiment the means to provide an electrical potential is a radio frequency field generator.

In one embodiment electrical insulation means are provided to electrically insulate the flow tube from the remainder of the instrument.

In another form the invention is a method of improving the signal intensity of the precursor ions constrained in a carrier gas in the flow tube of a SIFT-MS instrument substantially as herein described with reference to the accompanying drawings.

In yet another form the invention is a SIFT-MS instrument substantially as herein described with reference to FIG. 1 of the accompanying drawings.

### BRIEF DESCRIPTION OF THE DRAWINGS

FIG. 1 is a diagrammatic view of a typical SIFT-MS instrument illustrating one form of the application of an electrical potential to the flow tube.

FIG. 2 illustrates the gain in ion counts (and therefore the reduction in diffusive loss of ions) measured at the downstream end of the flow tube when the voltage is applied.

FIG. 3 illustrates the effect of flow tube voltage on the measurement of analyte concentration for a mixture of benzene, toluene and xylene.

FIG. 4 illustrates the effect of flow tube voltage on the measurement of analyte concentration for acetone.

### BEST MODE OF PERFORMING THE INVENTION

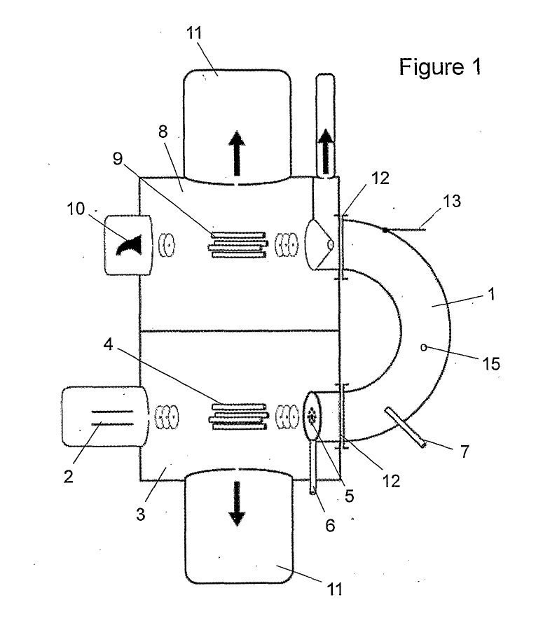

The method of the invention is performed by applying a relatively small voltage (typically 5V to 50V) to the flow tube of a SIFT-MS instrument. The SIFT-MS instrument illustrated in FIG. 1 is of the type described in WO 2005/052984.

FIG. 1 illustrates in diagrammatic form a SIFT-MS instrument having a curved flow tube 1. The instrument includes an ion source 2, an upstream chamber 3 housing a quadrupole mass filter 4 where the reagent ions are selected, a venturi 5 located at one end of the flow tube 1, and a carrier gas inlet 6 and a sample inlet 7 to the flow tube. The downstream end of the flow tube communicates with the downstream chamber 8 housing a quadrupole mass filter 9 where the product ions are analysed. The instrument also includes the usual form of particle multiplier 10. Outlets 11 connected to vacuum pumps (not shown in the drawing) are provided to evacuate chambers 3 and 8.

An electrical potential may be applied to the flow tube 1 of the instrument supplied from any appropriate power supply. The electrical potential will generally range between −100 VDC to +100 VDC, but this range can be varied considerably to suit particular circumstances.

While in a highly preferred form the electrical potential is direct current, it may also be alternating current or could be applied by a radio frequency field.

In one form the electrical potential is applied to the flow tube at electrode 13, but the method and location of application can be varied as required. In embodiment illustrated, the flow tube 1 is electrically insulated, for instance at 12, from the rest of the instrument. In a highly preferred form, a suitable vacuum insulator of known form is located between the ends of the flow tube and the chamber at or adjacent the location 12. The carrier gas inlet 6 and sample inlet 7 must also be electrically insulated from the flow tube.

In another embodiment, an electrode illustrated diagrammatically at 15 can be located within the flow tube and suitably connected to a source of electrical potential. This electrode can take various shapes and forms, such as, but not limited to, electrically conductive gauze and the specific position within the flow tube will vary according to the requirements.

Preferably but not necessarily, when positive ions are present in the ion swarm a positive electrical charge will be applied to the flow tube and when negative ions are present in the ion swarm, a negative charge will be applied to the flow tube.

There is difference between a drift tube voltage gradient described in WO 2005/052984 and the voltage applied to a flow tube according to the present invention. The drift tube uses a potential gradient to accelerate the ions in the flow tube towards the sampling port downstream. This acceleration reduces the residence time of the ions in the flow tube from what it would have been had there been no voltage gradient. In contrast, in the present invention, a voltage is being applied to the flow tube for the purpose of reducing the tube axis-to-wall loss of ions (this loss is called radial diffusion). The applied voltage does not accelerate the ions and does not reduce the residence time of the ions in the flow tube (as the potential gradient in the drift tube of WO 2005/052984 does).

### EXAMPLE 1

### Effect of Varying Voltages Applied to Flow Tube on Ion Signal

A SIFT-MS instrument as shown in FIG. 1 was operated to generate a flow of H₃O⁺ and O₂⁺ precursor ions from ion source 2 through flow tube 1. In this example, no sample analyte was injected.

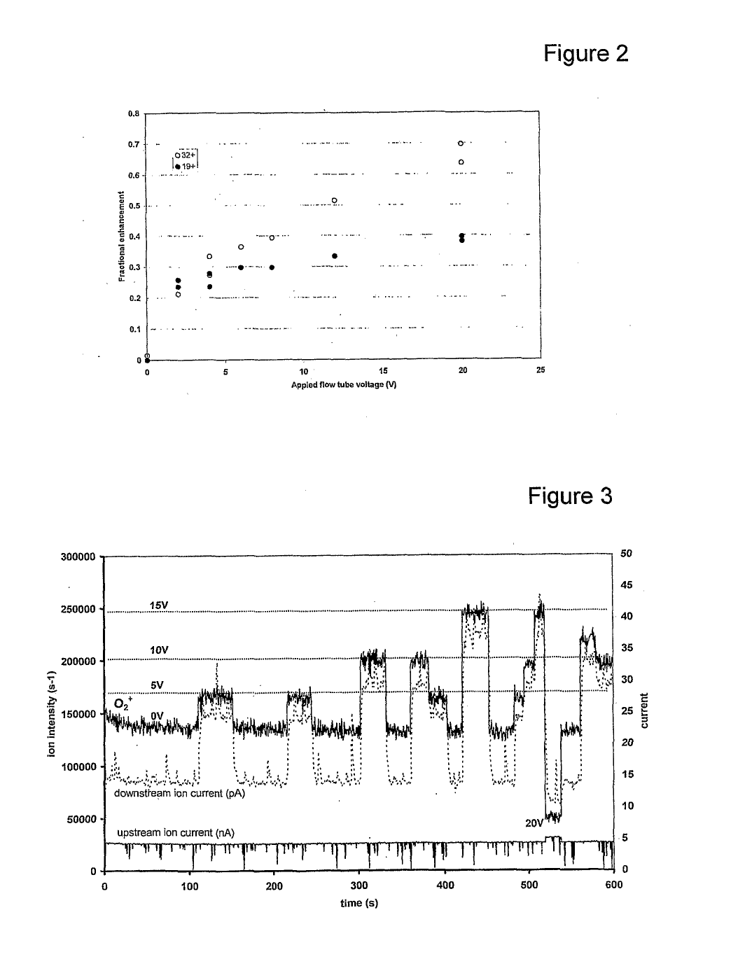

Different voltages were applied to the flow tube 1 at electrode 13. The strength of the ion signal from the H₃O⁺ and O₂⁺ precursor ions was measured for each of the applied voltages at the downstream end of the flow tube 1. The results are shown graphically in FIG. 2.

FIG. 2 shows the effect of different applied voltages on the ion signal from H₃O⁺ and O₂⁺ precursor ions at the downstream end of the flow tube. The increase in precursor ion signal for each of H₃O⁺ (m/z=19) and O₂⁺ (m/z=32) is shown. Data in this figure show that when voltages of between 0 V and 20 V were applied, an increase in ion signal designated for each applied voltage was observed.

Increasing the voltage applied to the flow tube establishes, a voltage gradient and an ion energy that is different from that when no voltage is applied. It has been found that when the applied voltage is less than 20 V the effect on the measurement of analyte concentration is small. The flight time of the ions along the flow tube is not substantially altered from the flight time with no voltage applied. The measurement of an analyte concentration requires the measurement of the ratio of at least two different ions having two different m/z values. These two ions are the precursor ion and the product ion(s) resulting from the reaction of the precursor ion with the analyte.

### EXAMPLE 2

### Effect of Varying Voltages Applied to Flow Tube on Ratio of Precursor Ions to Product Ions

A SIFT-MS instrument as shown in FIG. 1 was operated to generate a flow of H₃O⁺ and O₂⁺ precursor ions from ion source 2 through flow tube 1. In this example, sample analytes were injected through sample inlet 7. The ratio of precursor ions to product ions exiting from the flow 1 was measured, both when a voltage was applied to flow tube 1 and when it was not. This was done to determine whether an applied voltage alters the ratio of precursor ions to product ions. If the ratio were to vary when a voltage was applied the accuracy of the measurement of the sample would be adversely affected.

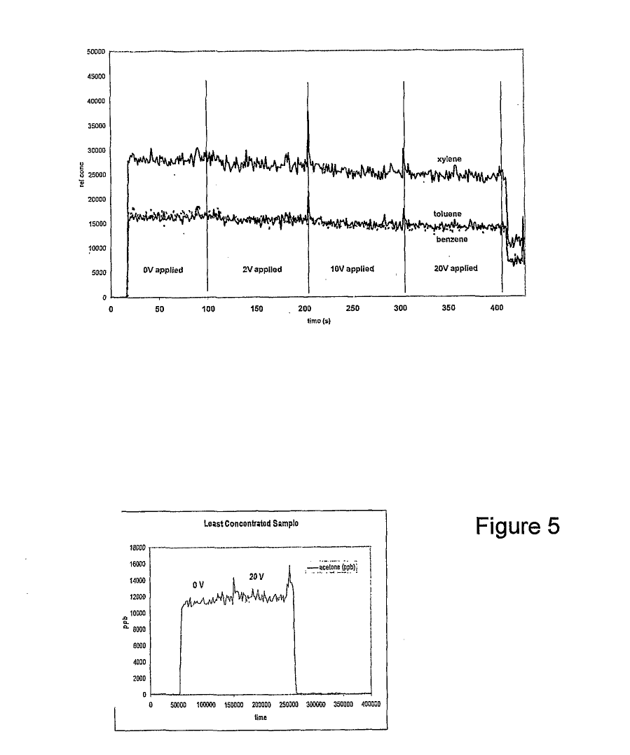

FIG. 3 shows the concentrations of a mixture of benzene, toluene and xylene measured using the kinetics data base at voltages up to 20 V.

FIG. 4 shows the measured concentration of acetone at 0 V and 20 V using the same existing kinetics. It is apparent that no significant change in the ratio of product ion(s) to precursor ion with the applied voltage is observed.

It is therefore apparent that the application of an electrical potential to the flow tube of a SIFT-MS instrument has an unexpected and significant effect on the signal intensity of the precursor ions at the downstream end of the flow tube. This improvement in signal intensity can be obtained by the application of electrical potentials of quite a broad range with different intensities resulting from the application of different voltages.

Having described preferred methods of putting the invention into effect, it will be apparent to those skilled in the art to which this invention relates, that modifications and amendments to various features and items can be effected and yet still come within the general concept of the invention. It is to be understood that all such modifications and amendments are intended to be included within the scope of the present invention.

1. A method of improving the signal intensity of the precursor ions constrained in a carrier gas in the flow tube of a SIFT-MS instrument comprising:
application of an electrical potential to the flow tube to lower the diffusive loss of ions within the flow tube.

2. A method as claimed in claim 1, wherein the electrical potential is direct current.

3. A method as claimed in claim 1, wherein the electrical potential is in the range of −100 VDC to +100 VDC.

4. A method as claimed in claim 1, wherein the electrical potential is in the range of between +1 VDC to +50 VDC

5. A method as claimed in claim 1, wherein the electrical potential is in the range of between +5 VDC to +50 VDC.

6. A method as claimed in claim 1, wherein the electrical potential is alternating current.

7. A method as claimed in claim 1, wherein the electrical potential is a radio frequency field.

8. A method as claimed in claim 1, wherein the flow tube is electrically insulated from the rest of the SIFT-MS equipment to allow the electrical potential to be applied to the flow tube.

9. A method as claimed in claim 1, wherein the electrical potential is applied to the wall of the flow tube.

10. A method as claimed in claim 1, wherein the electrical potential is applied to the flow tube by means of an electrode located within the flow tube.

11. A method as claimed in claim 1, wherein the electrical potential is a negative voltage.

12. A method as claimed in claim 1, wherein the electrical potential is a positive voltage.

13. A method as claimed in claim 1, wherein the applied electrical potential is a positive polarity when positive precursor ions are being sampled.

14. A method as claimed in claim 1, wherein the applied electrical potential is a negative polarity when negative precursor ions are being sampled.

15. A SIFT-MS instrument comprising:
a flow tube; and
means to provide an electrical potential to the flow tube to lower the diffusive loss of ions within the flow tube.

16. A SIFT-MS instrument as claimed in claim 15, wherein the means to provide an electrical potential is a source of direct current.

17. A SIFT-MS instrument as claimed in claim 15, wherein the means to provide an electrical potential is a source of alternating current.

18. A SIFT-MS instrument as claimed in claim 15, wherein the means to provide an electrical potential is an electrode located within the flow tube.

19. A SIFT-MS instrument as claimed in claim 15, wherein the means to provide an electrical potential is a radio frequency field generator.

20. A SIFT-MS instrument as claimed in claim 15, wherein electrical insulation means are provided to electrically insulate the flow tube from the remainder of the instrument.

21-22. (canceled)
